(19) United States
(12) Patent Application Publication
(10) Pub. No.: US 2009/0218857 A1
(43) Pub. Date: Sep. 3, 2009

(54) Device for Adjusting the Angle of Inclination of a Saddle

(75) Inventor: Udo Ochendalski, Frechen (DE)

Correspondence Address: GIFFORD, KRASS, SPRINKLE,ANDERSON & CITKOWSKI, P.C, PO BOX 7021, TROY, MI, 48007-7021, US

(73) Assignee: Udo Ochendalski, Frechen (DE)

(21) Appl. No.: 12/063,524

(22) PCT Filed: Aug. 7, 2006
(86) PCT No.: PCT/EP2006/007792

§ 371 Date: Aug. 30, 2008

(30) Foreign Application Priority Data
Aug. 12, 2005 (DE) 102005038565.8

(51) Int. Cl. B62J 1/08; B62J 1/00

(52) U.S. Cl. 297/215.15

(57) ABSTRACT

The invention relates to a device (1) for adjusting the angle of inclination of a saddle (2), preferably consisting of a plastic and/or metal materials for two-wheeled means of transport, preferably bicycles. Said device (1) can be arranged between the saddle (2) and the saddle tube (3) in a functionally efficient manner. According to the invention, the adjustment of the angle of inclination of the saddle (2) is simplified in that the device is embodied in the form of a transmission such that the angle of inclination can be adjusted by means of the device (1) in a continuously-regulated manner.

### CROSS-REFERENCE TO RELATED APPLICATIONS

This application is the U.S. national phase of international patent application PCT/EP2006/007792 filed Aug. 7, 2006, which claims priority to German patent application DE 10 2005 038 565.8 filed Aug. 12, 2005.

### FIELD OF THE INVENTION

The invention relates to a device for adjusting the angle of inclination of a seat, preferably made of plastic and/or metal, for two-geared means of transport, preferably bicycles, where the device between the seat and the seat support tube is arrangeable in a functionally effective manner.

### BACKGROUND OF THE INVENTION

In the state of the art, different devices for adjusting the angle of inclination of a seat are known. Thus, a device has been described (DE 203 08 663 U1), which, in principle, is provided as a complete seat with a setting device located in the seat for adjusting the angle of inclination. The setting of the angle of inclination here occurs by loosening two perforating bushing screws and the following adjustment on the basis of a predetermined step-shaped lock profile in the subsequent tightening of the two continuous screws.

DE 102 53 575 B3 describes a device in which the seat is adjustable with the aid of a force triangle connected to the bicycle frame, for the continuously regulated adjustment of the inclination and the height. A rider, with the aid of an adjustment element which effects a shift of the force triangle, is able to vary the seat position. In the process, the seat position changes as a result of the shifting of the triangle located in swivel bearings, which simultaneously can always change the height, the inclination of the seat, as well as the center of gravity.

DE 196 06 801 A1 shows a device for a bicycle seat with variable inclination adjustment of the seat by means of a remote-triggered gas spring. The device here consists of a special seat including the support tube and the gas spring which is attached to the seat end and to the support tube. By means of a triggering line which has been repositioned to the handle bars, the length of the gas spring can be changed by the transmission, which allows changing the angle of inclination of the seat.

In most bicycles intended primarily for sports, there is no possibility of adjusting the angle of inclination of the seat as a whole, although these bicycles, given their price range, based on the material used and the optimization possibilities frequently required for use in sports, would certainly be expected to allow a precise adjustment of the angle of inclination of the seat. Here, the continued use of the also usually high-quality material, such as, for example, support tube and seat, would be desirable.

High-performance cycling athletes with high ambition require, in particular, a comfortable seat position on the bicycle. For example, if the seat is made of the most novel material, such as, for example, carbon fiber, it may not have any padding, such as, for example, in the case of a racing bicycle. In this case it is particularly important that the angle of inclination of the seat be adjustable to allow the user to achieve an acceptable seat position on the bicycle.

In practice, the known possibilities of the state of the art for adjusting the angle of inclination of a seat are not optimal. On the one hand, the known devices frequently require a certain bicycle model on which the device can be applied fittingly, or else they may require significant refitting measures on the frame. Other devices are offered as seats to be used as a complete replacement part which includes an additional new support tube, so that an existing seat can no longer be used, even if it is perfectly fine. In the case of sport bicycles, where extreme attention is paid to material and weight, many of the known devices can not be used in practice. Moreover, devices are known where the angle of inclination of the seat can be adjusted, and where at least one, preferably even two, fixation screws have to be loosened first; then the seat must be positioned at the desired angle of inclination, and at first it must be held manually, at this same angle of inclination, before the appropriate fixation screws are tightened again to fix the seat at the same adjusted angle of inclination. Consequently, the adjustment is exceedingly complicated and possibly problematic, because the seat must be held manually at a certain angle of inclination while the other hand then tightens the fixation screws, or the presence of another person may even be required to assist in the adjustment. Using the above-described devices it is therefore not possible, particularly using a provided locking mechanism, or a given screw clamping, to adjust a precise angle of inclination for a seat. The result therefore is that the known devices of the state of the art do not yet present optimal designs.

The problem of the invention therefore is to design and develop a device of the type mentioned in the introduction, in such a manner that the adjustment of the angle of inclination of the seat is improved, particularly simplified.

### SUMMARY OF THE INVENTION

The problem described above has now been solved by designing the device in terms of its transmission so that a continuously regulated adjustment of the angle of inclination of the seat is possible with the device.

The basic concept of the invention therefore is to indicate a simple possibility which, while also allowing, in particular, the continued use of the already high-quality material of an already existing bicycle together with an adaptive device according to the invention, achieves a precise, continuously regulated adjustment of the angle of inclination by means of a device with a transmission-like design, as an excellent advantage. Because the design of the device is now transmission-like, first a simple and precise adjustment of the angle of inclination of the seat is achieved; particularly a continuously regulated adjustment of the angle of inclination can be achieved in a particularly simple manner. Furthermore, the device can now also be designed—adaptively—as a separate device, and arranged between a seat and a support tube, so that already existing bicycles can be refitted easily. It is, however, also conceivable to arrange such a device directly on a seat and/or on a support tube (seat support tube), in such a manner that it is appropriately “integrated directly” in the bottom area of the seat or the upper area of the support tube, i.e., it is already a component of a seat or of a support tube. This depends on the given application case. Using the device according to the invention, the adjustment of the angle of inclination of the seat can be set precisely and particularly simply. As a result, it is possible to optimize the force transmission during sports cycling, for example, in longer mountain climbs. Using the device according to the invention, a predetermined angle of inclination of a seat can now be adjusted easily in a simple manner and also appropriately reproducibly, so that a safe and comfortable driving experience for the rider can be achieved. With the aid of the device according to the invention, which can be used particularly for touring, but also for city riding or trekking, the seat position is now adjustable for all body positions on the bicycle, so that the user, that is, the rider, can assume a comfortable sitting position, which has a positive effect on safety in difficult riding situations. The seat which has been set with the device according to the invention now causes—in contrast to the prior state of the art—no pain to the rider, because the continuously regulated adjustment of the angle of inclination of the seat allows an optimal setting, which increases riding safety and rider comfort. The disadvantages described above are avoided, and corresponding advantages are achieved, which will be explained in greater detail below.

The concept “continuously regulated adjustment” in the sense of the present invention indicates that any desired angle of inclination of the seat can be set by means of the device which has a transmission-like design. In particular, the term continuously regulated adjustment in the sense of the present invention does not include a locking mechanism, as it is known in many instances in the state of the art. The continuously regulated adjustment of the angle of inclination in the sense of the present invention here occurs preferably within an angle of inclination range of 0° to 360°, preferably greater. This provides, in a particularly advantageous manner, a holding device for the seat stay of the seat whose angle of inclination can be adjusted on the device according to the invention, which holding device also receives seat stays of different diameters. For this purpose, a holding means can be arranged on the device according to the invention, which, particularly together with a rotatable first element, form two parallelogram clamps with different separations and thus two recesses for the seat stays, so that seat stay diameters particularly of 7 mm and 8 mm, or even 9 mm, can be fixed with the holding means on the device according to the invention. In the case of the installation of seats with different seat stay diameters, it is therefore possible to perform a simple rotation of the rotatable first element, for example, by approximately 180°, which element is received in a manner such that it can move in the design which has a transmission-like design, so that a seat with another seat stay diameter, which is adapted to the separation of this second parallelogram clamp, can then be installed simply over the second parallelogram clamp.

In a particularly preferred embodiment of the device according to the invention, the holding means for the attachment of the seat over its seat stays is connected directly or indirectly, preferably directly, to the rotatable first element. If the transmission of the device with a transmission-like design presents a preferably self-locking design, the result is that an uncoupling can occur during, on the one hand, the adjustment of the angle of inclination of the seat, and, on the other hand, during the adjustment of the seat longitudinal direction. In the process, the adjustment of both the inclination of the angle and also the longitudinal adjustment of the seat can occur with a high degree of precision because, in particular, due to the self-locking design of the transmission a positive-locking engagement of the individual transmission parts can allow, on the one hand, the adjustment of the angle of inclination with a precision of less than 1°, where this adjustment is fixed as a result of the self-locking, and as a result of loosening the holding means, for example, which is arranged preferably directly on the rotatable first element of the transmission-like device, the longitudinal adjustment of the seat can occur, without a simultaneous change in the angle of inclination. This represents a substantial improvement in contrast to the seat supports known from the state of the art, whereby loosening the holding means, which holds the seat stays of a seat, generally requires simultaneously the adjustment of the angle of inclination and also of the longitudinal setting of the seat, so that a precise setting is simply not possible.

The rotatable first element is preferably of cylindrical shape; moreover, it is preferably designed as a rotating barrel with a threading arranged on the external peripheral surface of said rotating barrel. The threading can be arranged on the entire external peripheral surface of the rotating barrel, or it may also be arranged on only parts of said rotating barrel, preferably in a middle partial area of the external peripheral surface. As a result of the cylindrical design of the rotating barrel, a simple possibility is provided to adjust the angle of inclination of the device according to the invention in a continuously regulated manner and fix it securely over the entire range of 0 to 360° and greater. In principle, it is preferred in the sense of the present invention for the rotatable first element to be designed with rotation symmetry, to allow a precise adjustment of the angle of inclination in a range between at least 0° and 360°, preferably greater. The rotatable first element is designed preferably without a stop. The rotatable first element can also, for example, be designed in the form of a gear, preferably in the form of a bevel gear, or in the form of a spur gear. The rotatable first element is preferably arranged so that it can move freely within a recess of the device according to the invention, where, to ensure the secure reception of the rotatable first element within the recess of the device, one must ensure on the one hand that the rotatable first element can be moved and, on the other hand, that only the slightest possible gaps are provided between the external peripheral surface of the rotatable first element and the internal peripheral surface of the recess, to largely prevent free play of the rotatable first element in the recess.

In a particularly preferred embodiment of the present invention, a fixation takes place additionally, particularly by clamping the first element, particularly with a clamp seat of the housing of the device according to the invention, which seat presents the recess. As a result, after the fine setting of the angle of inclination and the independent longitudinal adjustment of the seat, which is decoupled from the fine setting, an additional final fixation can be achieved, by means of which, on the preferably self-locking transmission of the device according to the invention, acting forces can be deflected as well.

A special advantage of the device according to the invention is that, particularly in the case of a direct connection of the holding means for the seat stays on the rotatable first element, a small, simply constructed device is achieved that can also be manufactured cost-effectively.

It is preferred for the rotatable first element to work similarly to a transmission together with an adjustment device. This adjustment device also presents preferably a threading, which also engages preferably with a positive locking in the threading arranged on the external peripheral surface of the rotatable first element. Here, it is particularly advantageous for the adjustment device to present a marking by means of which the angle can be adjusted with targeted precision. Because the angle marking is applied on the adjustment element and not on the rotatable first element, the adjustment of the angle of inclination occurs independently of the overall fixation of the device according to the invention, which, in addition and advantageously, reliably prevents adjusting of the angle in the advantageously carried out additional fixation of the rotatable first element via the clamp seat of the housing. Another advantage is the setting of the angle of inclination with precise degree via the marking on the adjustment device without the application of additional forces, as occurs in the state of the art, for example, due to the tightening of screws.

The angle scale or angle marking can be provided preferably on the setting device in its head area, which can be manipulated either manually or preferably via an adjustment means, such as an Allen wrench, by being rotated. The adjustment device in the sense of the present invention is designed preferably so it is nonmoving, while the rotatable first element is designed so that the angle of inclination of the seat can be adjusted within a range of at least 0° to 360°, and greater.

The securing of the adjustment device, particularly in the case of a screw-like design of the adjustment device, can occur by arranging, in the head area, a recess, particularly an annular groove, where a securing element engages from outside with this recess, which element can be introduced through a corresponding opening in the housing of the device. In addition, a reliable assignment of the adjustment device to the rotatable first element is established, ensuring in particular a positive-locking interaction of these parts of the device according to the invention.

### BRIEF DESCRIPTION OF THE DRAWINGS

Now, numerous possibilities exist to design and develop the device according to the invention in an advantageous manner. For this purpose, reference is made first to the claims that follow claim 1. Below, several preferred embodiments of the device according to the invention are described in greater detail with the aid of the following drawings and the associated description. In the drawings:

FIGS. 1a-1c show the device according to the invention in the preferred first embodiment as an exploded drawing in a schematic representation or with partially enlarged individual representations;

FIGS. 2a-2c show the device according to the invention from FIG. 1 with different perspective views in a schematic representation, arranged on a support tube;

FIG. 3 shows the device according to the invention from FIG. 1 in a side view, arranged between the support tube and a seat, in a schematic representation;

FIG. 4 shows the device according to the invention from FIG. 1 in a side view in a schematic functional representation without seat;

FIG. 5 shows a second embodiment of the device according to the invention in a side view in a schematic representation;

FIG. 6 shows a third embodiment of the device according to the invention in a side view in a schematic representation, and

FIG. 7 shows the device according to the invention from FIG. 1 in an assembled state on a support tube, but without a seat, although with a provided angle scale in a schematic representation.

### DETAILED DESCRIPTION OF THE INVENTION

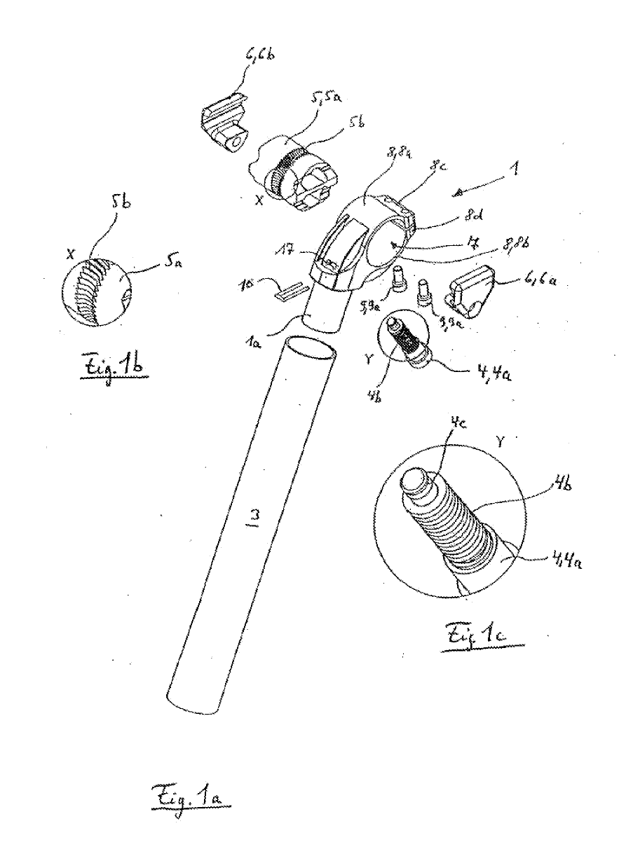

FIGS. 1-6 show—at least partially—a device 1 for the adjustment of an angle of inclination of a seat 2 of a two-geared transportation means—not shown in greater detail here—for example, of a bicycle. Here, seat 2 is preferably made of plastic, leather and or metal.

The device 1, here represented in FIGS. 1-6, can be arranged in a functionally effective manner between the seat 2 and a support tube 3 (seat support tube). Here, the device 1 can be arranged as separate individual device 1 between a separate seat 2 and a support tube 3, or—as an alternative—it is also conceivable for the device 1 to be designed as an integral component of a seat 2 or of a support tube 3. This depends on the given application case. As a result it is essential that the device 1 between the seat 2 and the support tube 3 be arrangeable in a functionally effective manner, or be designed appropriately here.

The disadvantages described in the introduction have now been avoided by the fact that the device 1 is designed in a transmission-like manner so that with the device 1 a continuously regulated adjustment of the angle of inclination of the seat 2 is possible. As a result, several decisive advantages are achieved. On the one hand, the device 1 can be handled easily by hand, and in the process the appropriate angle of inclination of the seat 2 can also be adjusted easily in a continuously regulated manner, which can also be exactly reproduced at any time. This will be explained in greater detail below:

FIGS. 1-3 show the preferred first embodiment of the device 1. Here, the device 1 has a transmission-like design and it presents a rotatable first element 5. The rotatable first element 5 is designed here preferably as a kind of rotating barrel 5a with a threading 5b provided in the middle area, which can be seen readily in FIGS. 1a and 1b. However, the threading 5b can also extend over the entire length of the rotating barrel 5a, or other partial areas of the latter.

On this rotatable first element 5, the seat 2 can be attached by means of a holding device 6. In other words, with a rotatable first element 5, that is, in this case, preferably the rotating barrel 5a, the holding device 6 then also turns the seat 2 for the adjustment of the appropriate angle of inclination. The holding device 6 here presents two separate side pieces 6a and 6b, which can be linked by an effective connection in each case with the rotating barrel 5a, i.e., if the rotating barrel 5a turns, then the corresponding side pieces 6a and 6b, respectively, of the holding device 6 are correspondingly swiveled as well, where the angle of inclination of the seat 2 is then also set, because the seat 2 is connected appropriately with the holding device 6, that is with the side pieces 6a and 6b, with an appropriate effective connection, or it can be attached here.

Because the device 1 has a transmission-like design, the first element 5 works in collaboration with an adjustment device 4, which is designed here preferably as an adjusting screw 4a. The adjusting screw 4a presents a threading 4b, which engages with the threading 5b of the first element 5. FIG. 1b here shows the appropriately designed threading 5b of the first element 5. Together, the adjusting screw 4a with the threading 4b, as shown clearly in FIG. 1c, and the rotatable first element 5, here form a worm gear.

The element 5 and the adjusting screw 4a are preferably designed in such a way that, in general terms, the element 5 and an adjustment device 4 that works in collaboration with the element 5, the engagement of the pitches of the screw threads is designed structurally to be self-locking. This has the advantage that, during the adjustment with the adjustment device 4, the newly selected angle of inclination sets itself without any risk of the angle changing again of its own—during the adjustment or the installation—as a result of vibration, impacts, etc. Thus, it is advantageous that the rotatable first element 5, which is designed as a rotating barrel 5a, and the adjusting screw 4a, here form a self-locking worm gear. The adjustment device 4 itself may also be actuated with an additional screw wrench. Therefore, it is preferred for the device 1 to be designed similarly to a transmission, namely as a self-locking transmission for adjusting the angle of inclination of the seat 2.

The advantage of the preferred first embodiment here particularly resides in that the angle of inclination of the seat 2 can be adjusted, with the aid of the adjustment device 4, preferably the adjusting screw 4a, precisely and manually, especially with the fingers, that is, without any addition tool and/or any additional apparatus. As a result—as already mentioned—an easy and precise adjustment of the angle of inclination of the seat 2 also becomes possible.

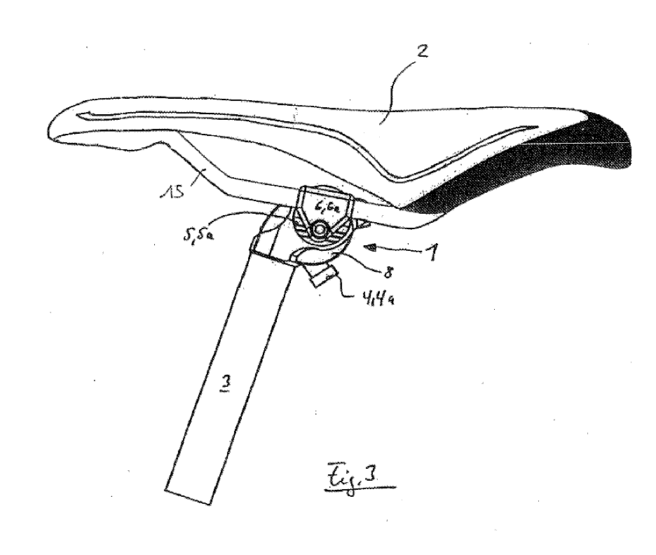

FIGS. 1-3 show the individual components of the device 1 or of the remaining component parts. It is also easy to see the device 1 arranged in FIG. 3 between the seat 2 and the support tube 3. With the aid of the adjustment device 4 or of the adjusting screw 4a, the device 1 which has a transmission-like design can be “actuated,” namely the rotatable first element 5 can be turned so that the angle of inclination of the seat 2 can be adjusted. The individual components of the device 1 are represented clearly in the exploded representation in FIG. 1.

One can easily see in FIGS. 1a-1c that the adjusting device 4 is designed as a adjusting screw 4a which engages with the rotatable first element 5, and the threading 4b of the adjusting screw 4a can be engaged with, or is engaged with, the threading 5b of the rotatable first element 5, which is designed here in the manner of a rotating barrel 5a.

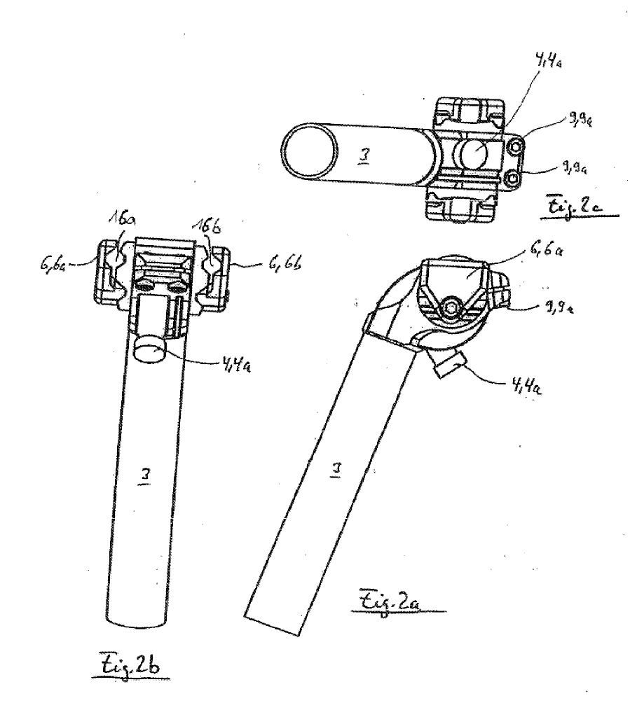

It is preferable to use the rotatable first element 5 movably in a recess 7 of a housing 8, as can be seen easily in FIGS. 2a-2c. Here, the housing 8 is designed uniquely, in particular, it presents two housing parts or housing areas 8a and 8b. The arrangement of the first rotatable element 5 inside the recess 7 of the housing 8 is designed as a clamp seat where, as a result of a precisely fit insertion of the element 5 into the recess 7, already almost without clearance, a reliable reception of the element 5 becomes possible. For this purpose, the two housing parts 8a and 8b can be clamped together. Then, after adjusting the angle of inclination via the clamp seat of the housing 8, the first element 5 is then additionally attachable, preferably by a separate fixation device 9, namely, preferably by means of two appropriately designed fixation screws 9a that can appropriately connect the flanges 8c and 8d of the housing parts 8a and 8b, respectively, and then fix and clamp the first element 5.

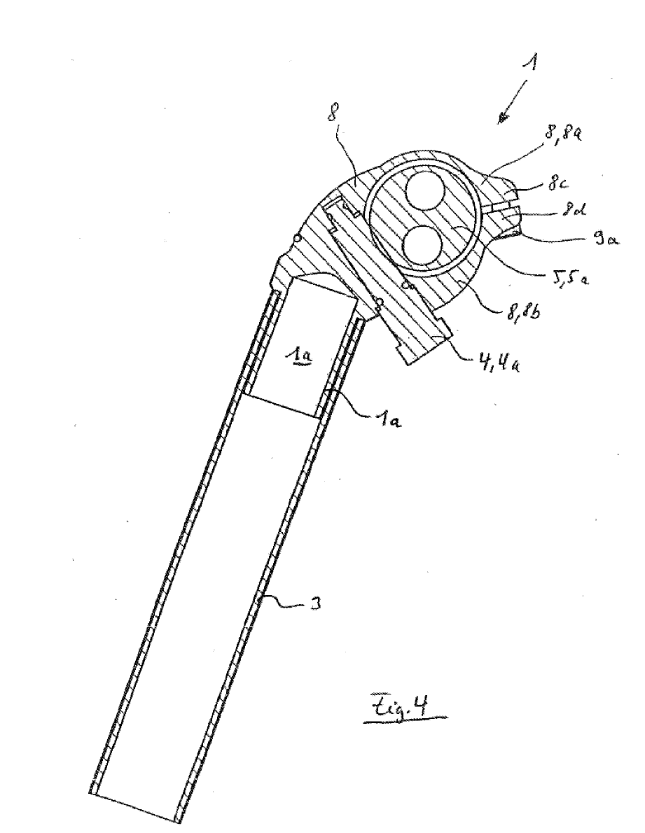

FIG. 4 illustrates particularly the functioning of the device 1. Schematically represented here are the adjustment device 4, namely the adjusting screw 4a, and the rotatable first element 5, namely the rotating barrel 5a, which are arranged in the housing 8, in accordance with the recesses provided here. Clearly visible are also the two housing areas 8a and 8b, or, respectively, the flanges 8c and 8d, which can be clamped together via the fixation screws 9a, so that the element 5 is fixable. Other components, such as the seat or the holding device 6, are not represented individually, rather only the an arrangement of the device 1 is shown with a seat support tube adapter section 1a in the support tube 3.

To be also able to fix the adjustment device 4, particularly the adjusting screw 4a, in particular against undesired slipping-out of the recess formed for them in the housing 8, a fastening element 10 can work in collaboration with a groove 4c of the adjusting screw 4a. A corresponding fastening element 10, which preferably has a clamp-like design, and is insertable through a recess 17 of the housing 8 to engage at least partly with the groove 4c, is represented in FIG. 1.

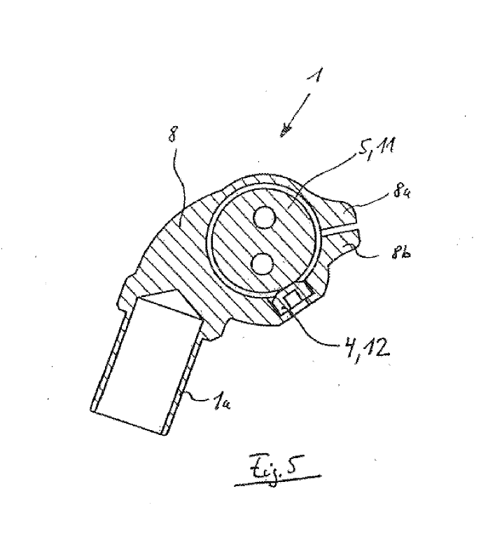

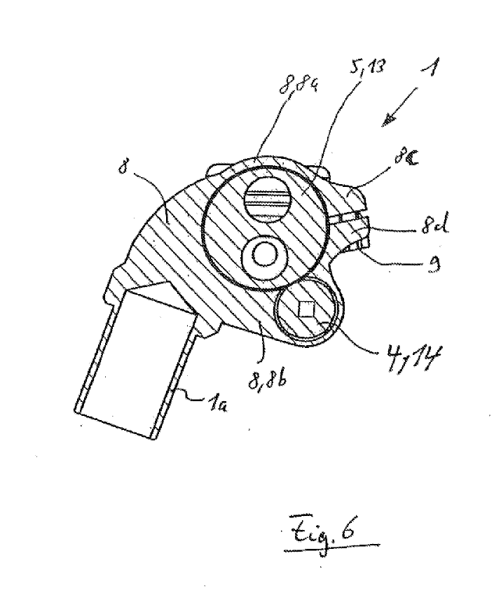

FIGS. 5 and 6 show two additional embodiments of the device 1 according to the invention.

FIG. 5 shows a second embodiment. Here, the device 1 presents two bevel gears 11 and 12, where now the rotatable first element 5 is designed as a first bevel gear 11, and the second bevel gear 12 is designed so that it can be used simultaneously as an adjustment device 4. It is preferred for the second bevel gear 12 to present an appropriate “Allen wrench contact place” for adjusting the corresponding angle of inclination. The rotation axes of the two bevel gears 11 and 12 preferably form a right angle.

In the device represented in FIG. 6, the transmission constructed here presents two spur gears 13 and 14, as shown in the representation. The rotatable first element 5 thus is designed here as a first spur gear 13 and the adjustment device 4 as a second spur gear 14. It is also preferred for access to be provided from outside through a gap-shaped cutout, which then implements the corresponding setting function, so that rotating the spur gear 14 resets the spur gear 13, and thus the angle of inclination of the seat can be changed. The rotation axes of the two spur gears 13 and 14 preferably present mutually parallel axes.

The device 1 represented in FIGS. 1-6 is substantially always placed on or shifted on the support tube 3, as shown from the side. For this purpose, the device 1 presents the seat support tube adapter section 1a. Via the holding device 6, the seat 2 can be arranged on the given rotatable first element 5.

FIGS. 1-6 show a design of the holding device 6, which is connected immediately, i.e., directly, with the rotatable first element 5, i.e., the side pieces 6a and 6b which are associated with said holding device 6, by means of which device only a single specific diameter of a seat stay 15 is made possible via a separation—which is predetermined by the holding device 6 in cooperation with the element 5—of a single parallelogram clamp with two recesses 16a and 16b. However, the holding device 16 with its side pieces 6a and 6b, and, correspondingly, also the element 5, on its front sides which can be engaged laterally from outside the housing, can also present or form a second recess 16 (not shown), with mirror symmetry, which presents another separation of a second parallelogram clamp which is predetermined by this second recess, in comparison to the first parallelogram clamp formed by the first recess 16. Each front surface of the element 5 is thus associated in each case with two paired recesses 16 for seat stays, which present different gaps in their parallelogram clamps to receive seat stays of different diameters, for example, of 7 mm and 8 mm, or also 9 mm. Because of the design according to the invention of the rotatable first element 5 in a preferably rotation-symmetrical form, without a stop, not even a stop for a rotation of 360°, it is possible, therefore, for example, by simply turning the rotatable first element within the recess 7 of the housing 8 of the device 1, by, for example, 180°, to bring the second recess 16 for the seat stays 15 into a position in which another seat 2 can be installed with a larger seat stay diameter. The recesses 16 can here also be arranged exclusively in the holding device 6, which is then connectable with the element 5.

Thus, a simple adjustment of the angle of inclination of the seat 2 is possible with the holding device 6, which preferably presents two associated side pieces 6a and 6b, respectively, which in turn are connectable with the corresponding rotatable first element 5, that is, with the rotating barrel 5a, or the conical or spur gear 11 or 13. In the process, the adjustment device 4, as described above, can be designed either preferably as a adjusting screw 4a or also as an additional bevel gear 12 or spur gear 14. In the two last cases, the corresponding bevel gear or spur gear 12 and 14, respectively, present a corresponding contact place, so that a user can turn the corresponding gear to move the rotatable first element 5 accordingly, to thus reset the angle of inclination of the seat 2.

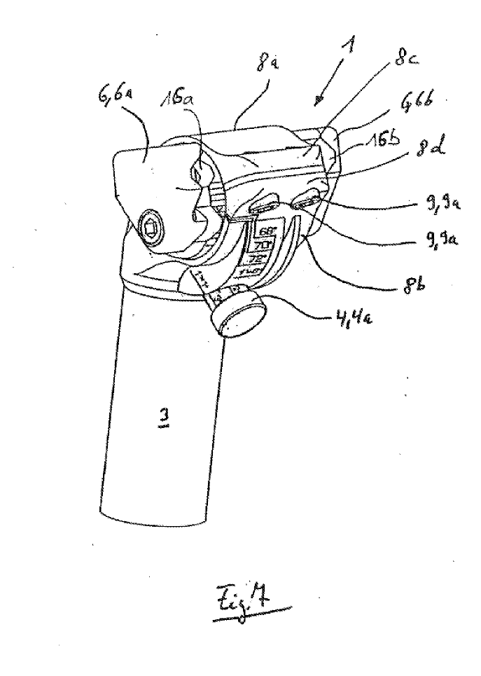

It is essential that the device 1 present a transmission-like design here, that is, a rotatable first element 5 and an adjustment device 4. It is preferred that the rotatable element 5 as well as the adjustment device 4 be designed as transmission components, particularly mutually engaging threadings and/or gear steps. The latter is the case when the rotatable element 5 is designed in the shape of a gear, particularly a bevel gear or a spur gear, and it is actuated appropriately by of an additional rotatable element, namely the adjustment device 4, preferably by an additional bevel gear and/or spur gear. Due to the transmission-like design of the device 1 according to the invention, particularly in the form of the worm gear represented in FIGS. 1a-1c, a continuously regulated precise adjustment of the angle of inclination of the seat 2 is possible, including by means of an applied angle scale—as represented in FIG. 7—, particularly if the device 1 is designed as a self-locking worm gear. It is also conceivable to provide, between the adjustment device 4 and the rotatable element 5, additional components and/or gear-like elements, particularly to achieve an optimal setting of the transmission ratio of the adjustment device and the rotatable first element. The specific arrangement of these individual components within the housing 8 of the device 1 can then be entirely different for each given application case, particularly the specific design of the rotatable first element 5 or of the adjustment device 4. This depends on the given application case.

Finally, FIG. 7 again shows the device 1, mounted on a support tube 3, but without the seat 2. One can clearly see here the two-part design of the holding device 6, namely the two side pieces 6a and 6b, which are firmly connected in each case with the rotatable first element 5, preferably the rotating barrel 5a, which is attached in the housing 8, particularly here with screws, not designated in detail. By means of the adjustment device 4, preferably the adjusting screw 4a, the rotatable first element 5, i.e., in the final effect, the side pieces 6a and 6b, can be moved, to move the seat 2—not shown here—i.e., to achieve the continuously regulated adjustment of the angle of inclination. As FIG. 7 shows, moreover, an angle scale is provided here. It is designed so that in the case of a complete 360° rotation of the adjusting screw 4a, the angle of inclination of the seat 2 is reset by 6°. In the case of corresponding partial rotations of the adjusting screw 4a, a corresponding precise exact adjustment of the angle of the seat 2 is possible, where this adjustment of the angle of inclination can also be reproduced again at any time. It is conventional to use for bicycles known angles, i.e., the slanted position of the support tube 3, which fall between 68° and 72°. Here too, the device 1 presents a corresponding scale at the outer margin of the housing 8, to achieve a corresponding adjustment of the angle of the angle of inclination of the seat 2 in a particularly simple manner in comparison to the given specific preexisting angle of the support tube 3.

In the final effect, the fixation screws 9a, for the adjustment of the angle of inclination of the seat 2, are first loosened, then the angle of inclination of the seat 2 is adjusted appropriately with the aid of the adjusting screw 4a, particularly with the aid of the angle scale, where then the first element 5 itself with the first element 5 side pieces 6a and 6b and thus the seat 2 is swivelled to adjust the angle of inclination. Because the device 1 presents a transmission-like design, particularly one that is self-locking, the angle of inclination of the seat 2 can be adjusted with only one hand, preferably via the adjusting screw 4a. Then, the fixation screws 9a are subsequently fixed again, so that the rotatable element 5 is fixed reliably in the housing 8, or between the housing parts 8a and 8b in a certain position. Repetition of the adjustment of an angle of inclination is thus always exactly reproducible, particularly with the aid of the angle scale. The adjustment device 4 is preferably operated manually, however, it is also conceivable to carry out the adjustment by means of an additional tool, preferably an allen wrench, or another screw wrench or other tool, which can preferably be engaged with the adjustment device 4. A readjustment of the angle of inclination of the seat 2 is also always possible without problem.

As a result, with the device 1 according to the invention, a simple manner is provided for adjusting the angle of inclination of a seat 2, while avoiding the disadvantages mentioned in the introduction.

1. A device (1) for adjusting the an angle of inclination of a seat (2), preferably made of plastic and/or metal, for two-geared means of transport, preferably bicycles, where the device (1) between the seat (2) and a seat support tube (3) is arranged in a functionally efficient manner, characterized in that the device (1) is designed similarly to a transmission such that the device (1) allows continuously regulated adjustment of the angle of inclination of the seat (2).

2. The device according to claim 1, characterized in that a rotatable first element (5) is provided on which the seat (2) can be arranged directly or indirectly by means of a holding device (6).

3. The device according to claim 2, characterized in that the rotatable first element (5) is designed as a kind of rotating barrel (5a) with a threading (5b) provided in the central area.

4. The device according to claim 2, characterized in that an adjustment device (4) is provided, and the adjustment device (4) works in collaboration with the rotatable first element (5) in such a manner that the angle of inclination of the seat (2) can be adjusted.

5. The device according to claim 2, characterized in that the element (5), or an adjustment device (4) which works in collaboration with this element, is designed so that its construction is self-locking, so that during the adjustment with the adjustment device (4), the newly chosen angle of inclination sets itself firmly, without any risk of it changing again on its own due to vibration, impacts, etc.

6. The device according to claim 4, characterized in that the adjustment device (4) is designed as an adjusting screw (4a) which is engaged with the rotatable first element (5).

7. The device according to claim 6, characterized in that the adjusting screw (4) presents a threading (4b), which is engaged with the threading (5b) of the rotatable first element (5).

8. The according to claim 7, characterized in that the threading (4b) of the adjusting screw (4) and the threading (5b) of the rotatable first element (5) form a worm gear.

9. The device according to claims claim 2, characterized in that the seat of the rotatable element (5) is designed as a clamp seat of housing parts (8a, 8b) that can be clamped together.

10. The device according to claim 6, characterized in that the adjustment device (4) is fastened by means of a fastening element (10) in a manner such that the adjusting screw (4) can be loosened completely only if the clamp seat is separated.

11. The device according to claim 9, characterized in that, after adjusting the angle of inclination via the clamp seat of the housing (8), the first element (5) can additionally be fixed again.

12. The device according to claim 9, characterized in that the housing parts (8a, 8b), which form the clamp seat, present in each case a flange (8c, 8d) in whose area an additional fixation device (9) can be arranged.

13. The device according to claim 12, characterized in that the fixation device (9) is designed as at least one, preferably two, fixation screws (9a) which connect the two flanges (8c, 8d) to each other.

14. The device according to claim 4, characterized in that an angle scale is provided so that with the adjustment device (4) the angle of inclination is precisely adjustable and/or also exactly reproducible.

15. The device according to claim 1, characterized in that the device (1) presents at least two bevel gears (11, 12).

16. The device according to claim 4, characterized in that the rotatable first element (5) is designed as a first bevel gear (11), and a second bevel gear (12) is designed in this manner and can be used simultaneously as adjustment device (4).

17. The device according to claim 1, characterized in that the device (1) presents at least two spur gears (13, 14).

18. The device according to claim 4, characterized in that the rotatable first element (5) is designed as a first spur gear (13) and the second spur gear (14) is designed in this manner and can be used simultaneously as adjustment device (4).
